(19) United States
(12) Patent Application Publication
(10) Pub. No.: US 2026/0256058 A1
(43) Pub. Date: Sep. 3, 2026

(54) VEHICLE SUPPORTING A GROUND WORKING IMPLEMENT

(71) Applicant: THE TORO COMPANY, Bloomington, MN (US)

(72) Inventor: Benjamin Allan Street, Northfield, MN (US)

(21) Appl. No.: 19/135,471

(22) PCT Filed: Dec. 20, 2023
(86) PCT No.: PCT/US2023/085027

§ 371 Date: Jun. 4, 2025

Related U.S. Application Data
(60) Provisional application No. 63/435,902, filed on Dec. 29, 2022.

(51) Int. Cl. A01D 67/00; A01D 34/00; A01D 34/47; A01D 34/58; A01D 101/00

(52) U.S. Cl. CPC A01D 67/00; A01D 34/006; A01D 34/475; A01D 34/58; A01D 2101/00

(57) ABSTRACT

A vehicle supporting a ground working implement such as a reel mower. The reel mower includes a reel assembly a drive drum adapted to propel the mower during mowing operation, and a transport wheel adapted to propel the mower during transport. The mower may include a lift system adapted to reconfigure the mower between: an operating configuration, wherein the drive drum is engaged with the ground surface and the transport wheel is elevated above the ground surface; and a transport configuration, wherein the drive drum is elevated above the ground surface and the transport wheel is engaged with the ground surface.

This application claims priority to and/or the benefit of U.S. Provisional Patent Application No. 63/435,902, filed 29 Dec. 2022, which is incorporated herein by reference in its entirety.

Embodiments described herein are directed generally to vehicles supporting a ground working implement such as a reel mower and, more specifically, to systems and methods adapted to reconfigure the vehicle/implement between operating and transport configurations.

### BACKGROUND

Reel mowers are well known, especially in the field of golf course management. Unlike rotary mowers, reel mowers typically include a series of helical (helix-shaped) blades spinning about a horizontal reel axis that is transverse to the direction of travel of the mower. A reel frame supporting the spinning blades also supports a bedknife. During operation, grass blades are sheared between the spinning blades and the bedknife at a pre-selected height of cut.

Walk-behind reel mowers are commonly used to mow golf course greens. In this instance, the mower may make a plurality of parallel, side-by-side cutting passes across a length of the green. At the end of each cutting pass, the reel is typically lifted while the mower is turned 180 degrees to align for the next pass. Depending on the mower construction, lifting of the reel and turning of the mower may require a series of manual operations to ensure turf damage is minimized and a high quality of cut is maintained.

### SUMMARY

Embodiments described herein provide a reel mower including a main frame rotatably supporting, and pivotable relative to, a powered drive drum, the drive drum configured to engage a ground surface and propel the reel mower when the reel mower is in an operating configuration by rotating about a transverse drum axis. The mower may also include: a reel subframe pivotally connected to the main frame about the transverse drum axis, the reel subframe supporting a powered cutting reel assembly; a trailing wheel subframe connected to the reel subframe; a powered transport wheel rotatably attached to the main frame at a location spaced-apart from the transverse drum axis, wherein the transport wheel is configured to engage the ground surface and propel the reel mower when the reel mower is in a transport configuration by rotating about a wheel axis parallel to the transverse drum axis; and an actuator operatively connected to the main frame and to the trailing wheel subframe. The actuator is adapted to pivot the main frame, relative to the reel subframe, about the transverse drum axis between: the operating configuration, wherein the drive drum is engaged with the ground surface and the transport wheel is elevated above the ground surface; and the transport configuration, wherein the drive drum is elevated above the ground surface and the transport wheel is engaged with the ground surface.

In another embodiment, a ground working vehicle is provided that includes a main frame configured to support a powered drive drum for rotation, relative to the main frame, about a transverse drum axis. The vehicle may also include: an implement subframe pivotally connected to the main frame about the transverse drum axis, the implement subframe supporting a ground working implement; a trailing wheel subframe pivotally connected to the implement subframe, the trailing wheel subframe comprising a castering wheel; a powered transport wheel rotatably attached to the main frame at a location spaced-apart from the transverse drum axis; and an actuator operatively connected to the main frame and to the trailing wheel subframe. The actuator is adapted to pivot the main frame relative to the implement subframe about the transverse drum axis between: an operating configuration, wherein the drive drum and the implement are engaged with a ground surface and both the transport wheel and the castering wheel are elevated above the ground surface; and a transport configuration, wherein the drive drum and implement are elevated above the ground surface and both the transport wheel and castering wheel are engaged with the ground surface.

Other embodiments described herein may provide a reel mower including a main frame rotatably supporting, and pivotable relative to, a powered drive drum, the drive drum configured to engage a ground surface and propel the reel mower when the reel mower is in an operating configuration by rotating about a transverse drum axis. The mower may further include: a trailing wheel subframe pivotally connected to the main frame about the transverse drum axis; a reel subframe supported by the trailing wheel subframe, the reel subframe supporting a powered cutting reel assembly; a powered transport wheel rotatably attached to the main frame at a location spaced-apart from the transverse drum axis, wherein the transport wheel is configured to engage the ground surface and propel the reel mower when the reel mower is in a transport configuration; and an actuator connected to the main frame and to the trailing wheel subframe. The actuator is adapted to pivot the main frame and the trailing wheel subframe about the transverse drum axis between: the operating configuration, wherein the drive drum is engaged with the ground surface and the transport wheel is elevated above the ground surface; and the transport configuration, wherein the drive drum is elevated above the ground surface and the transport wheel is engaged with the ground surface.

In another embodiment, a reel mower is provided that includes: a main frame having lateral first and second side plates that support a powered drive drum for rotation, relative to the main frame, about a transverse drum axis; and a trailing wheel subframe pivotally connected to the main frame about the transverse drum axis, the trailing wheel subframe including a castering wheel. The mower also includes: a reel subframe supported by the trailing wheel subframe, the reel subframe supporting a powered cutting reel assembly; a powered transport wheel rotatably attached to the main frame at a location spaced-apart from the transverse drum axis; and an actuator connected to the main frame and to the trailing wheel subframe. The actuator is adapted to pivot the main frame and the trailing wheel subframe about the transverse drum axis between: an operating configuration, wherein the drive drum is engaged with a ground surface and both the transport wheel and the castering wheel are elevated above the ground surface; and a transport configuration, wherein the drive drum is elevated above the ground surface and both the transport wheel and castering wheel are engaged with the ground surface.

In still another embodiment, a ground working vehicle is provided that includes: a main frame having lateral first and second side plates that support a powered drive drum for rotation, relative to the main frame, about a transverse drum axis; a trailing wheel subframe pivotally connected to the main frame about the transverse drum axis, the trailing wheel subframe having a castering wheel; and an implement subframe supported by the trailing wheel subframe, the implement subframe supporting a powered ground working implement. The vehicle also includes: a powered transport wheel rotatably attached to the main frame at a location spaced-apart from the transverse drum axis; and an actuator connected to the main frame and to the trailing wheel subframe. The actuator is adapted to pivot the main frame and the trailing wheel subframe about the transverse drum axis between: an operating configuration, wherein the drive drum is engaged with a ground surface and both the transport wheel and the castering wheel are elevated above the ground surface; and a transport configuration, wherein the drive drum is elevated above the ground surface and both the transport wheel and castering wheel are engaged with the ground surface.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a left front perspective view of a reel mower in accordance with embodiments of the present disclosure;

FIG. 2 is a right rear perspective view of the reel mower of FIG. 1;

FIG. 3 is a bottom perspective view of the reel mower of FIG. 1;

FIG. 4 is a partial left front perspective view of the mower of FIG. 1 with various structure removed;

FIG. 5 is a partial left front perspective view similar to FIG. 4 with yet additional structure removed;

FIG. 6 is a partial left front perspective view illustrating portions of a frame assembly of a reel mower in accordance with embodiments of the present disclosure;

FIG. 7 is a left side elevation view showing a reel mower in accordance with embodiments of the present disclosure in a transport configuration;

FIG. 8 is a left side elevation view showing the reel mower of FIG. 7 after transitioning to an operating configuration;

FIG. 9 is a left front perspective view of a reel mower in accordance with another embodiment of the present disclosure;

FIG. 10 is a partial left front perspective view of the mower of FIG. 9 with various structure removed;

FIG. 11 is a partial left front perspective view similar to FIG. 10 with yet additional structure removed;

FIG. 12 is a perspective view of a main frame of the reel mower of FIG. 9;

FIG. 13 is a perspective view of a reel subframe of the reel mower of FIG. 9;

FIG. 14 is a perspective view of the main frame and reel subframe of FIGS. 12 and 13 assembled to form a frame assembly;

FIG. 15 is a left side elevation view showing the reel mower of FIG. 9 in a transport configuration; and

FIG. 16 is a left side elevation view showing the reel mower of FIG. 15 after transitioning to an operating configuration.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about” unless otherwise indicated. The term “and/or” (if used) means one or all of the listed elements or a combination of any two or more of the listed elements. The term “i.e.” is used as an abbreviation for the Latin phrase id est and means “that is.” The term “e.g.” is used as an abbreviation for the Latin phrase exempli gratia and means “for example.”

In various embodiments of the present disclosure, a ground working vehicle (e.g., reel mower) is provided that includes a lift system adapted to lift a reel assembly during transport and turning of the mower upon a ground surface. The exemplary mower may also include a propulsion or drive system that allows a transport wheel of the mower to rotate at a ground speed equivalent to a ground speed of a powered drive drum of the reel assembly. As a result, abrupt changes in ground speed are minimized during transition between: an operating configuration, wherein the reel assembly (drive drum) is engaged with the ground surface and the transport wheel is elevated above the ground surface; and a transport configuration, wherein the reel assembly (drive drum) is elevated above the ground surface and the transport wheel is engaged with the ground surface. In some embodiments, the reel mower may operate autonomously, wherein the transition between operating and transport configurations may occur automatically. In yet other embodiments, the reel mower may be operated via a remote operator, in which case the lift system may be actuated remotely.

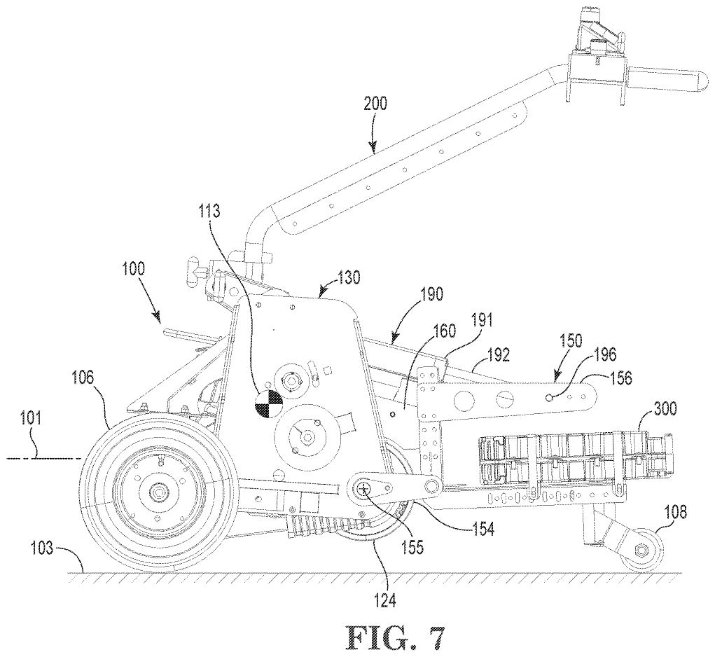

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the mower 100 is in an operating configuration (e.g., while the mower 100 is positioned such that wheels 106 and 108 rest upon a generally horizontal ground surface 103 as shown in FIG. 7). These terms are used only to simplify the description, however, and not to limit the interpretation of any embodiment described. In a similar manner, terms such as “first” and “second” may be used herein to describe various elements. However, such terms are used merely to distinguish one of the elements from the other, and the use of “first” does not necessitate the need for a “second.” It is further understood that the description of any particular element as being operatively attached, connected, or coupled to another element may indicate that the elements are either directly attached, connected, or coupled to one another, or are indirectly attached, coupled, or connected to one another via intervening elements.

Still further, the suffixes “a” and “b” may be used throughout this description to denote various left-and right-side parts/features, respectively. However, in most pertinent respects, the parts/features denoted with “a” and “b” suffixes are mostly identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

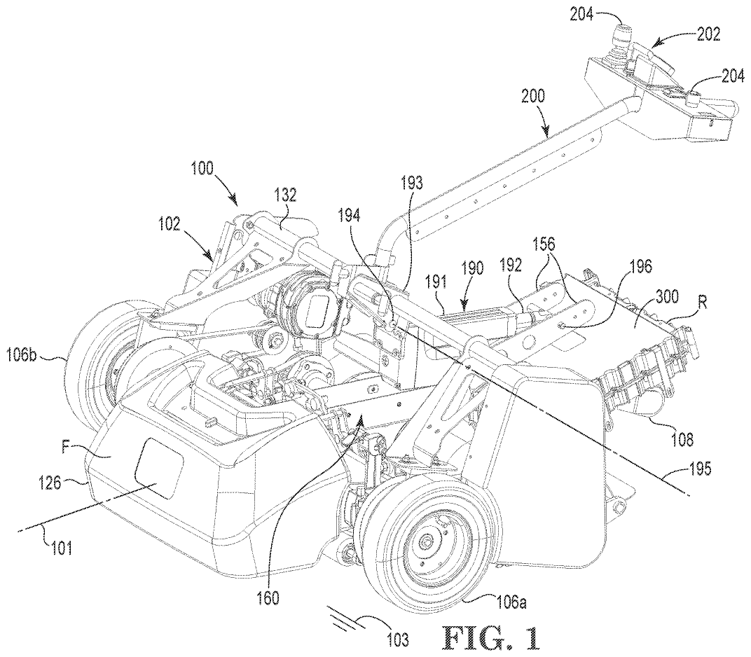

With reference to the figures of the drawing, wherein like reference numerals designate like parts and assemblies throughout the several views, FIGS. 1-3 illustrate an exemplary ground working vehicle configured as a reel mower 100 (shown in an operating mode or configuration in these figures, and in a transport mode or configuration in, for example, FIG. 7) in accordance with embodiments of the present disclosure. The mower 100 (also referred to herein as “vehicle”) may include a front end F, a rear end R, and a longitudinal axis 101 extending between the front and rear ends.

As shown in these views, the exemplary reel mower 100 may include a frame assembly 102 supported upon and relative to a ground surface 103 (when in the transport configuration) by ground engaging members that may include at least one powered transport wheel 106 (e.g., first transport wheel 106a located on a first or left lateral side of the frame assembly/main frame, and second transport wheel 106b located on a second or right lateral (opposite) side) and at least one trailing wheel 108. The powered transport wheels 106 may each rotate about a generally horizontal wheel axis 107 to effectively self-propel the mower in a direction parallel to the longitudinal axis 101 of the mower when the mower is configured in the transport configuration. Moreover, as further described below, speed and rotational direction of the transport wheels 106 may be independently controlled to allow the mower to change heading (e.g., execute turns). The trailing wheel 108, which may be configured as a passive castering wheel, may support a rear portion of the mower as further described below. While the wheels 106, 108 rest upon the ground surface 103 when the mower 100 is in the transport configuration, the wheels may be elevated (spaced-apart) from the ground surface when the mower is in the operating configuration, whereby portions of a reel assembly 110 (e.g., rollers 120, 122 and drive drum 124) then form the ground engaging members as further described below.

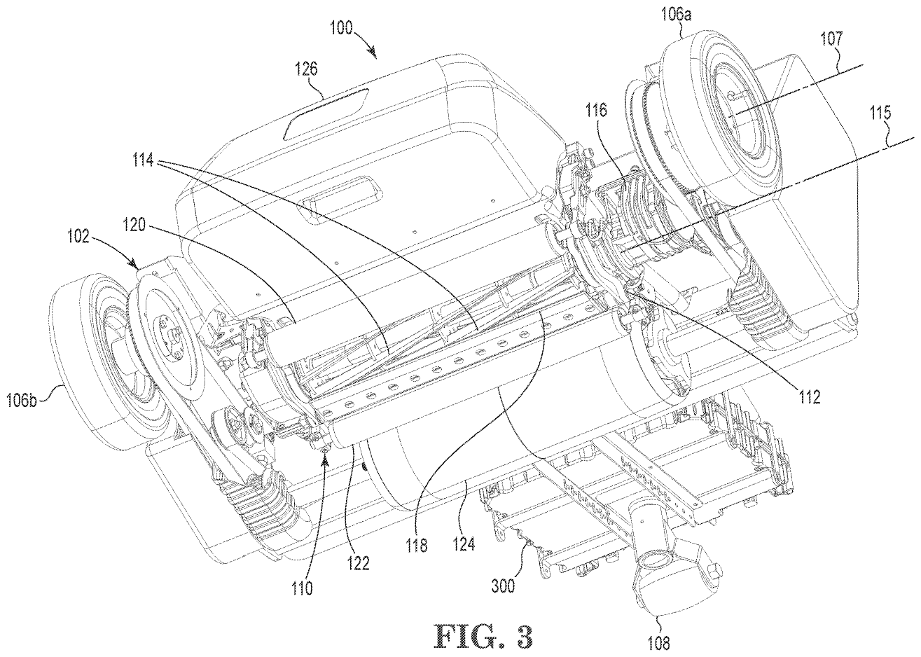

The vehicle may further include an implement subframe supporting a ground working implement. For example, when configured as a reel mower, the mower 100 may include a reel subframe 160 (which, as described below, is pivotally connected to a main frame of the mower about the transverse drum axis) supporting a powered cutting reel assembly 110 that includes a powered cutting reel 112 and the drive drum 124 (see FIG. 3). The cutting reel 112, as is known in the art, may include a series of helical blades 114 that rotate about a transverse reel axis 115. During operation of the cutting reel 112, the blades 114, powered by a reel motor 116, may rotate about the reel axis 115. As the blades 114 rotate and the mower 100 is propelled over the ground surface 103 by the drive drum 124, grass blades trapped between the blades 114 and a bedknife 118 of the cutting reel 112 are sheared at a preselected height of cut. While described herein in the context of a reel mower, embodiments of the present disclosure may have application to most any ground working vehicle. For example, the subframe 160 may support most any ground working implement (rotary cutting blade(s), aerator, de-thatcher, etc.) without departing from the scope of this disclosure.

In the illustrated embodiments, the reel motor 116 (as well as the propulsion motors 170 described below) are electric motors that receive power from an onboard energy storage device such as a battery pack 300. However, such a configuration is exemplary only as other embodiments may utilize other motors (e.g., hydraulic motors) and other power sources (e.g., hydraulic pumps, internal combustion engines).

The reel assembly 110 may further include front and rear rollers 120, 122 to support the cutting reel 112 relative to the ground surface 103 when in the operating configuration. To propel the mower 100 when in the operating configuration (e.g., during mowing), the drive drum 124 may be powered as further described below. An optional collection bin 126 may also be provided to collect grass clippings produced by the cutting reel 112.

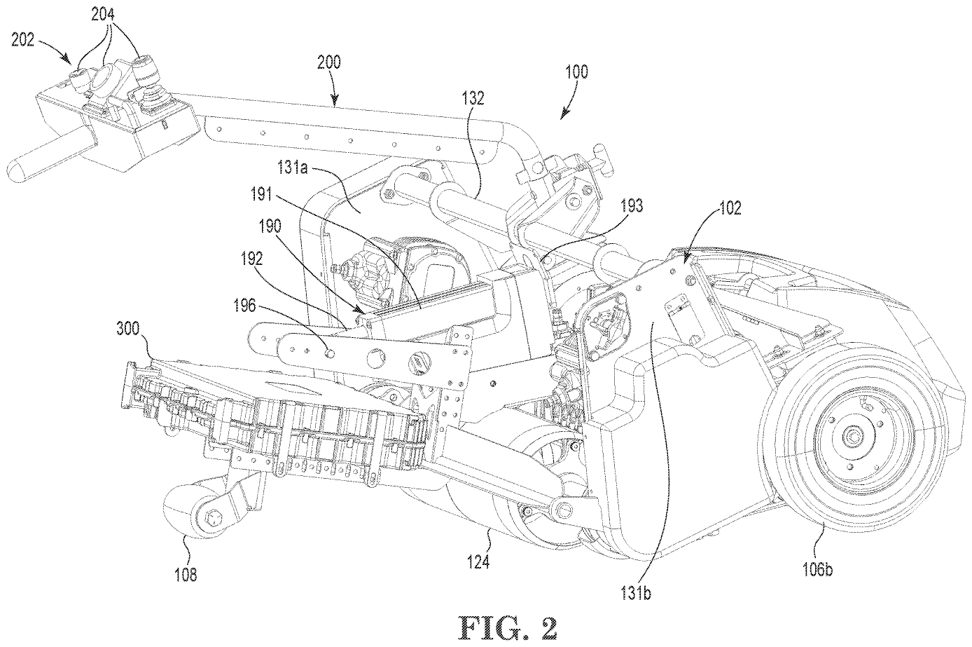

In some embodiments, the mower 100 may further include a handle or handle assembly 200 extending from the main frame as shown in FIGS. 1 and 2. The handle assembly 200 may be used to operate the mower manually, e.g., by an operator gripping a hand grip 202 and walking behind the mower during operation. In embodiments wherein the mower 100 is configured to operate autonomously (or via remote control), the handle assembly 200 may be optional and/or removable. For example, the handle assembly may be attached to the mower 100 to permit initial training of the autonomous mower by an operator who guides the mower around a boundary of the area to be mowed. Thereafter the handle assembly may be removed to permit autonomous operation with minimal interference that may otherwise result from the protruding handle assembly. Alternatively, the handle may remain attached to the mower, and optionally repositioned (e.g., rotated) rather than removed when the handle is not being used for mower training/manual operation. In some embodiments, the repositioned handle could support and locate various sensors for autonomous mower operation (e.g., vision sensors, infrared sensors, radio detection and ranging (radar) sensors, light detection and ranging (lidar) sensors, etc.). As shown in FIGS. 1 and 2, the handle assembly 200 may also include various controls 204 to permit manual operation and/or training of the mower 100.

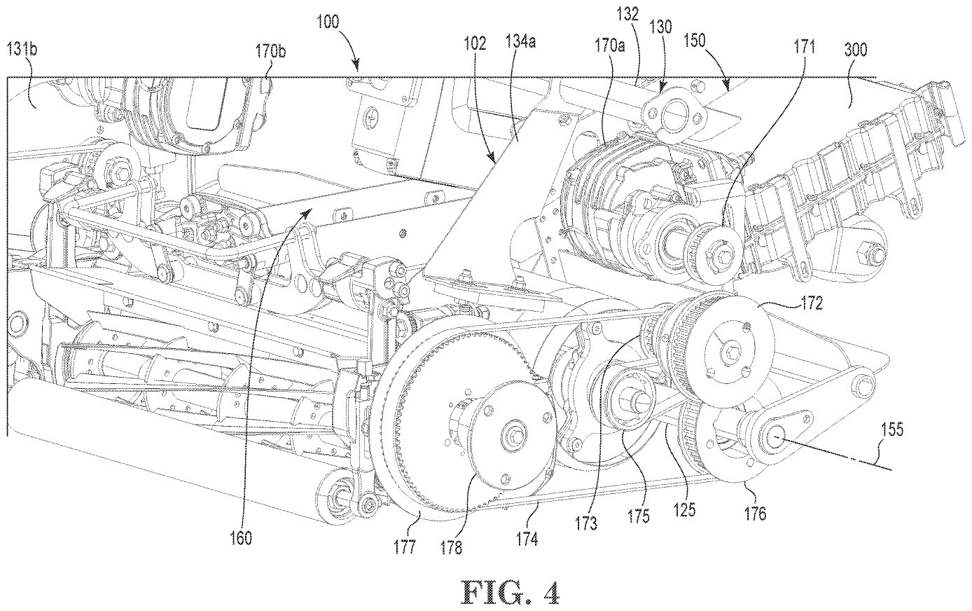

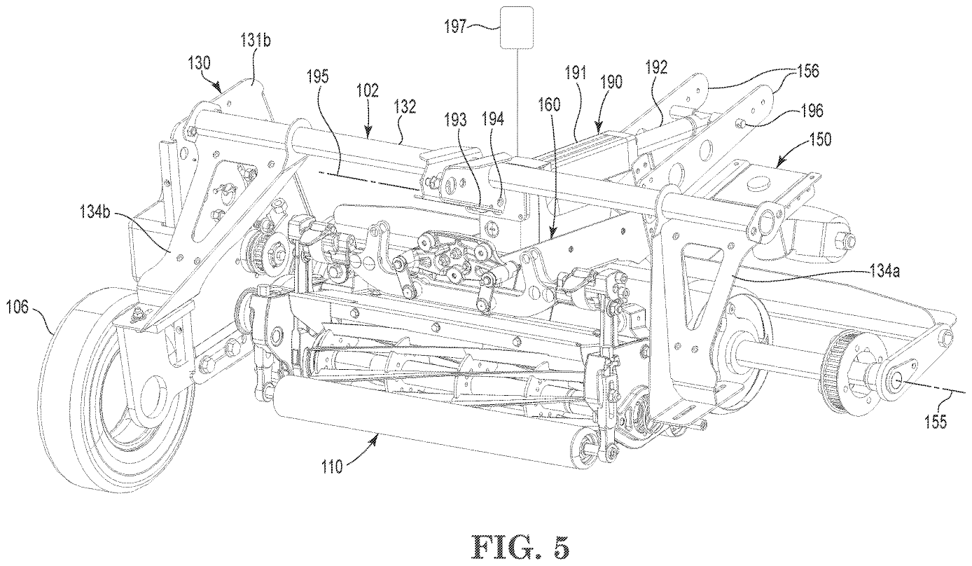

FIG. 4 is a partial perspective view of the mower 100 with various structure removed to better illustrate a propulsion system in accordance with embodiments of the present disclosure. The exemplary propulsion system may be configured to propel the mower when in both the operating (mowing) configuration and the transport (non-mowing) configuration. FIG. 5 is a similar view with additional structure removed to better illustrate various components of the frame assembly 102.

As indicated in these views, the frame assembly 102 may include a main frame 130, a trailing wheel subframe 150 operatively pivotally connected to the main frame about a transverse drum axis 155, and a reel subframe 160 supported by the trailing wheel subframe 150. The exemplary main frame 130 may include lateral first (left) and second (right) side plates 131 as shown in FIG. 5 (only right side plate 131b shown but corresponding left side plate is also provided) rigidly connected to one another by a transverse shaft or crossbeam 132. The crossbeam 132 may include left and right wheel support arms 134 (134a, 134b) that support the respective left and right transport wheels 106. The arms 134 are welded or otherwise fixed to the transverse crossbeam 132 such that the arms 134, crossbeam 132, and side plates 131 form a singular structure, e.g., the transport wheels are effectively rotatably attached to the main frame 130 at a location spaced-apart from the transverse drum axis 155.

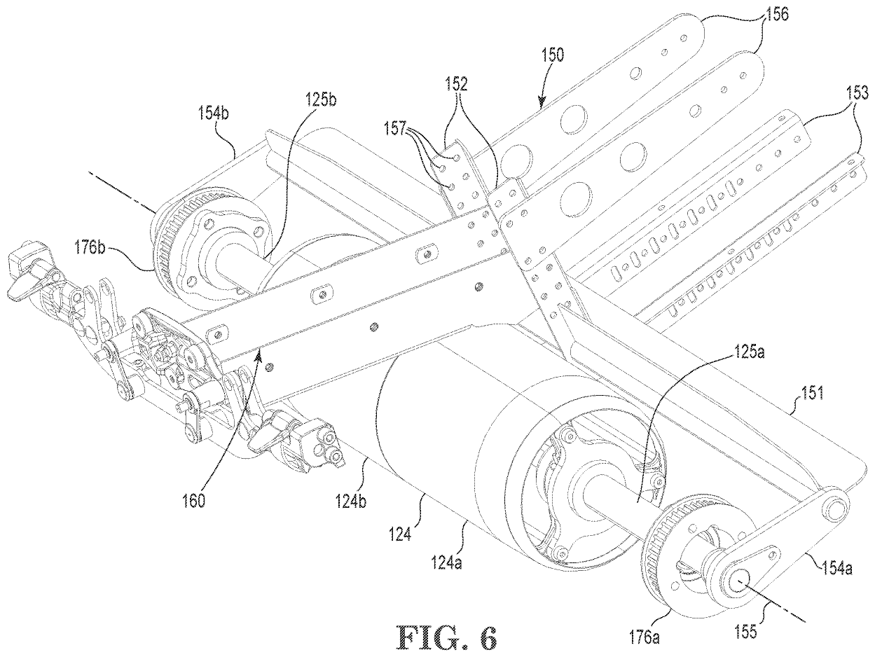

The trailing wheel subframe 150, along with the drive drum 124 and reel subframe 160, are shown in isolation in FIG. 6. As indicated in this view, the trailing wheel subframe 150 includes a transverse crossbar 151 rigidly supporting one or more frame rails 152 and one or more support rails 153. The subframe 150 is pivotally attached to the drive drum 124 via fixed arms 154 (154a, 154b) such that the trailing wheel subframe may pivot, relative to the drive drum (and thus the main frame 130) about the transverse drum axis 155. Stated alternatively, the main frame 130 rotatably supports, and is pivotable relative to, the powered drive drum 124.

As is evident in FIG. 6, the drive drum 124 may be split such that it includes independently rotatable, coaxial first (left) drive drum portion or section 124a and second (right) drive drum portion or section 124b (collectively the drive drum or drum sections 124) powered by the first (left) and second (right) propulsion motors 170a, 170b (see FIG. 4), respectively. Such a construction permits the drive drum sections 124a, 124b to control mower 100 direction (when in the operating (mowing) configuration) in a manner similar to a conventional zero turn vehicle. To provide this functionality, each drive drum section 124 may be powered (by its own propulsion motor 170; see FIG. 4) via its own drive shaft 125/drum sheave 176 as further described below. While described herein as “drums,” the drive drum sections may be configured as wheels, tracks, rollers, or most any other suitable drive member without departing from the scope of this disclosure.

As shown in FIG. 6, the reel subframe 160 may be connected to the trailing wheel subframe 150 via attachment to the frame rails 152 as shown. To provide adjustment, the frame rails 152 may include an array of attachment holes 157 to which the reel subframe may be fastened. Once the reel subframe 160 is attached to the trailing wheel subframe 150, the reel subframe 160 may move (e.g., pivot about the drum axis 155) in unison with the trailing wheel subframe 150.

With continued reference to FIGS. 4-6, an exemplary propulsion system for use with the mower may be powered by a power source, e.g., an energy storage device such as the battery pack 300, that, in some embodiments, is supported by the trailing wheel subframe 150. For example, in addition to securing the trailing wheel 108, the trailing wheel subframe 150 (e.g., the support rails 153) may provide structure to support the battery pack 300 as shown in, for example, FIGS. 1-3. The battery pack 300 may supply energy to at least: the electric reel motor 116 (see FIG. 3) to provide power to the reel assembly 110 (e.g., to rotate the helical blades 114); and first (left) and second (right) propulsion motors 170a, 170b secured to respective side plates 131a (see FIG. 2), 131b (e.g., to rotate the transport wheels 106a, 106b and/or the drive drum sections 124a, 124b, respectively) as indicated in FIG. 4.

As shown in FIG. 4, each propulsion motor 170 may include a motor sheave 171 adapted to power a main sheave 172 via a toothed belt (not shown). The main sheave 172 (which may be journalled to its respective side plate 131) may drive a shaft to which a drive sheave 173 is connected. A belt 174 may then be entrained about the drive sheave 173, an idler sheave 175 (also journalled to its respective side plate), a drum sheave 176 (rigidly attach to its respective drive shaft 125 so that it may power the corresponding drum section 124), and a wheel sheave 177 (configured to drive a hub 178 that supports the associated transport wheel 106). As one can appreciate, relative movement of the main frame 130, trailing wheel subframe 150, and reel subframe 160 has no impact on belt 174 tension as the respective (left and right-side) sheaves 171, 172, 173, 175, and 177 move in fixed relation to the transverse drum axis 155 (about which the sheave 176 rotates). As a result, all sheaves entrained by the belt 174 maintain their relative relationship as the mower 100 moves between the operating and transport configurations. Each propulsion motor 170 (170a, 170b) may drive both its respective wheel 106 (106a, 106b) and drum section 124a, 124b at the same ground speed. Stated alternatively, the first and second drum sections are driven at a ground speed equivalent to the ground speed of the first transport wheel and the second transport wheel, respectively during transition between the operating configuration and the transport configuration. As a result, transitioning between the operating configuration (wherein the drive drum 124/drum sections 124a, 124b engage the ground surface 103 and propel the reel mower 100) and the transport configuration (wherein the transport wheels 106 engage the ground surface and propel the mower) may occur smoothly and without abrupt ground speed changes.

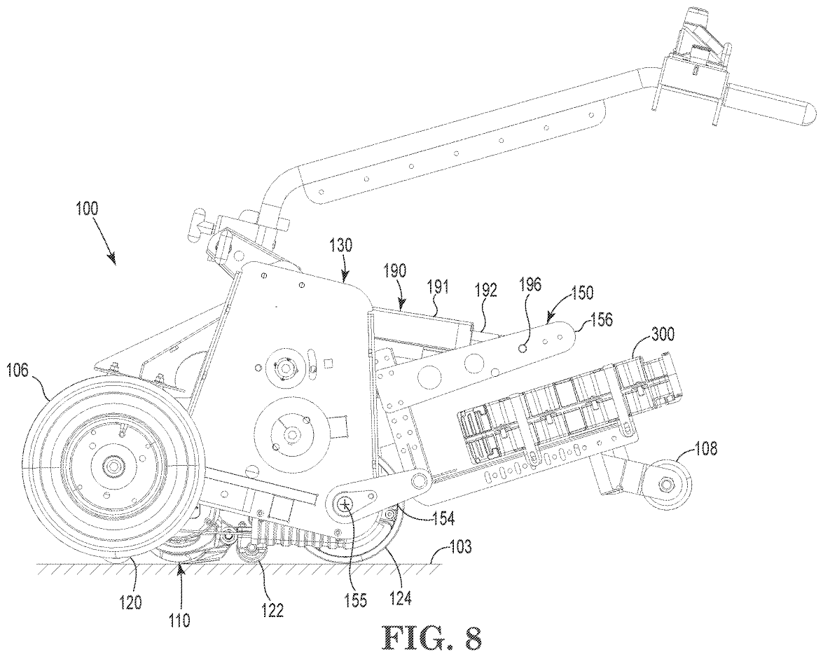

FIGS. 7 and 8 are partial side elevation views of the mower 100 in the transport configuration and the operating configuration, respectively. Once again, in the transport configuration as shown in FIG. 7, the reel assembly 110 (including the drive drum; see FIG. 3) is elevated above the ground surface 103, while the transport wheels 106 and the trailing wheel 108 may engage or rest upon the ground surface 103 to support the mower 100 thereon. Powered, differential rotation of the transport wheels 106 may then propel and control speed and direction of the mower by rotating about the wheel axis 107, the wheel axis being parallel to the drum axis.

Conversely, in the operating configuration shown in FIG. 8, the reel assembly 110 is lowered such that the front and rear rollers 120, 122 and the drive drum 124 engage or rest upon the ground surface 103, while the transport wheels 106 and the trailing wheel 108 are elevated or spaced-apart from the ground surface. Powered, differential rotation of the drive drum sections 124a, 124b about the transverse drum axis 155 may propel the reel mower 100 when in the operating configuration (e.g., control both speed and direction of the mower).

To reconfigure the mower 100 between the transport configuration (FIG. 7) and the operating configuration (FIG. 8), the mower 100 may include an actuator, e.g., electric linear actuator 190 connected to the main frame and the trailing wheel subframe and adapted to pivot the main frame, relative to the reel subframe, about the transverse drum axis. The actuator may include a housing 191 and a rod 192 that may selectively extend and retract from the housing. The housing 191 may include a pivot 194 (see also FIGS. 1 and 5) for pivotally attaching the actuator to a bracket 193 fixed to the transverse crossbeam 132 (e.g., the actuator may connect to the main frame 130) such that the actuator may pivot about an actuator pivot axis 195 (see FIG. 1). The rod 192 also includes a pivot 196 configured to pivotally attach a distal end of the rod 192 to portions (e.g., to frame extensions 156) of the trailing wheel subframe 150. In some embodiments, an electronic controller 197 (see FIG. 5) may be provided and operatively connected to the actuator 190. The controller may be configured to transition the mower 100 between the operating and transport configurations automatically, e.g., by energizing the actuator.

Starting in the transport configuration (FIG. 7), the mower 100 may transition to the operating configuration (FIG. 8) by retracting the actuator 190 (e.g., retracting the rod 192 relative to the housing 191). As the actuator 190 retracts, it generally causes the main frame (via the transverse crossbeam 132) to draw toward the trailing wheel subframe 150 (e.g., it causes the main frame 130 and the trailing wheel subframe to pivot about the transverse drum axis 155). As this occurs, the trailing wheel subframe 150 may pivot (counterclockwise in FIGS. 7 and 8) about the transverse drum axis 155. As this pivoting occurs, the reel subframe 160/reel assembly 110 will lower toward the ground surface 103 until the front and rear rollers 120, 122 and drive drum 124 rest thereon. During this transition, the trailing wheel subframe 150 will pivot, about the transverse drum axis 155 (in a counterclockwise direction in FIGS. 7 and 8), eventually lifting the trailing wheel 108 away from the ground surface 103. As the actuator 190 continues to retract, the main frame 130 (supporting the transport wheels 106) may also pivot (clockwise in FIGS. 7 and 8) about the transverse drum axis 155 (as it is drawn toward the trailing wheel subframe 150 by the actuator 190) until the transport wheels are lifted from the ground surface 103. Thus, as shown in FIG. 8, only the reel assembly 110 (cutting reel 112, rollers, 120, 122 and drive drum 124) are in contact with the ground surface 103 when the mower is in the operating configuration. To transition back to the transport position, the actuator 190 may be extended, generally reversing the process described above.

The movement of the relative components of the frame assembly 102 (e.g., the main frame 130, the trailing wheel subframe 150, and the reel subframe 160) may be influenced by a location of the center of gravity (CG) 113 of the mower 100 (see FIG. 7). More specifically, the desired movement of the frame assembly components as described above may occur because the CG is located at a longitudinal location at or forward of the transverse drum axis 155 (e.g., between the drum axis 155 and the transport wheel(s) 106) when the reel mower is in both the operating configuration and the transport configuration. The exact CG location may be selected and controlled to provide not only the desired transitional movement between the operating and transport configurations, but also to provide balanced and consistent operation of the mower in both configurations. The location of the CG may be adjusted by, for example, changing the length of the fixed arms 154 and/or the position (and size/weight) of the battery pack 300 on the trailing wheel subframe 150.

While shown in the accompanying illustrations with the handle assembly 200 attached, it may, as stated above, be optional or, alternatively, be removed when the mower is operating autonomously or via remote control.

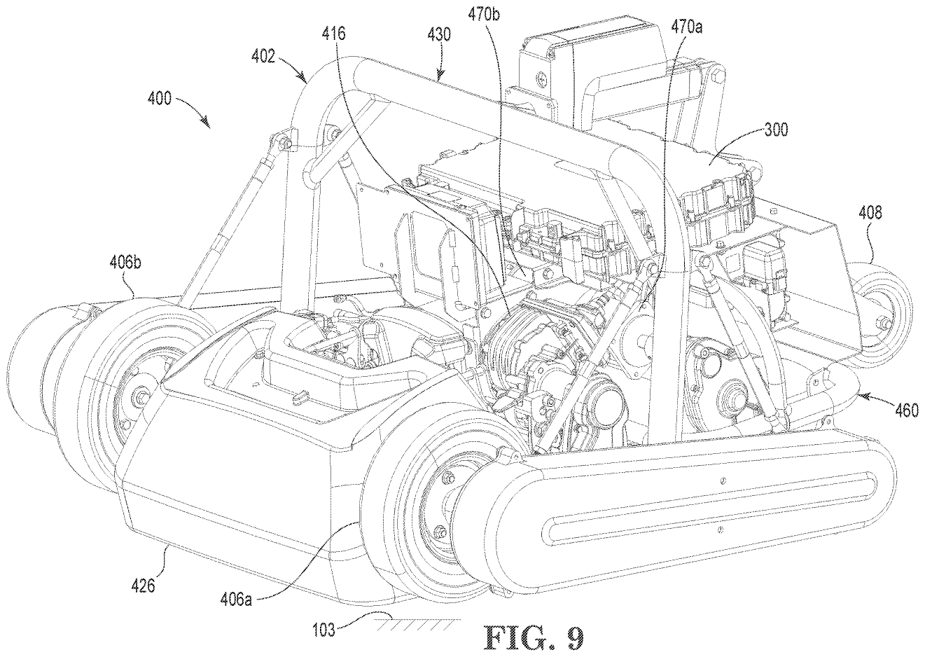

FIGS. 9-16 illustrate a reel mower 400 in accordance with another embodiment of the present disclosure. The reel mower 400 is similar in many respects to the reel mower 100 described herein. As a result, various components and subsystems of the reel mower 400 that are identical or similar to corresponding components and systems of the mower 100 are not described in detail herein. For convenience, components similar to components of the reel mower 100 may, for the most part, be indicated with the same series reference numerals (e.g., reference numeral 4xx of the reel mower 400 may correspond to reference numeral 1xx of the reel mower 100).

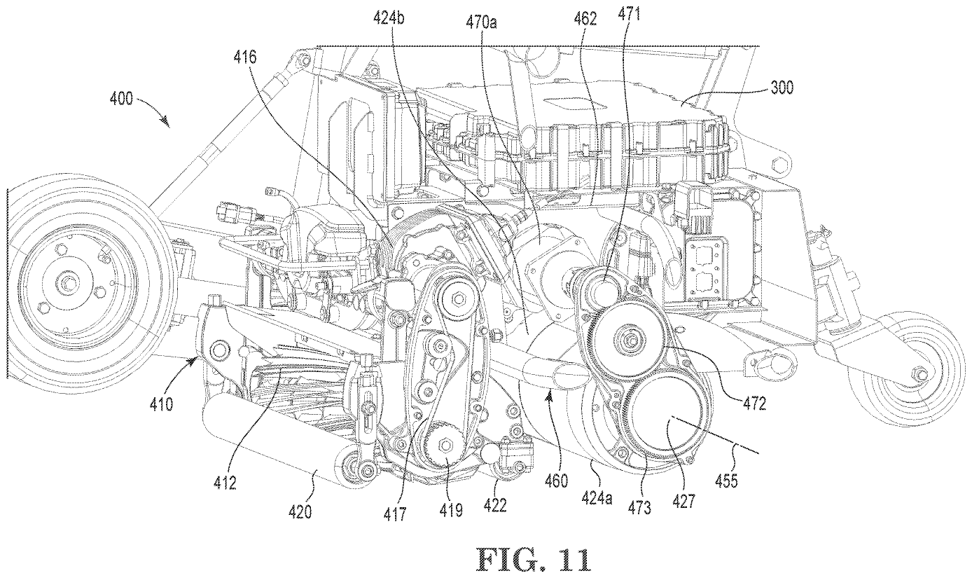

As shown in FIG. 9, The exemplary reel mower 400 may include a frame assembly 402 supported upon and relative to the ground surface 103 (when in a transport configuration) by ground engaging members that may include powered transport wheels 406 (e.g., first transport wheel 406a located on a first or left lateral side of the frame assembly, and second transport wheel 406b located on a second or right lateral (opposite) side) and at least one trailing wheel 408. As with the mower 100, speed and rotational direction of the transport wheels 406 may be independently controlled to allow the mower to change heading (e.g., execute turns). The trailing wheel 408, which again may be configured as a passive castering wheel, may support a rear portion of the mower when in the transport configuration as further described below. Like the mower 100, the wheels 406, 408 may be elevated (spaced-apart) from the ground surface 103 when the mower is in an operating configuration, whereby portions of a reel assembly 410 (e.g., rollers 420, 422 and drive drum 424 (sections 424a, 424 b); see FIG. 11) then form the ground engaging members as further described below.

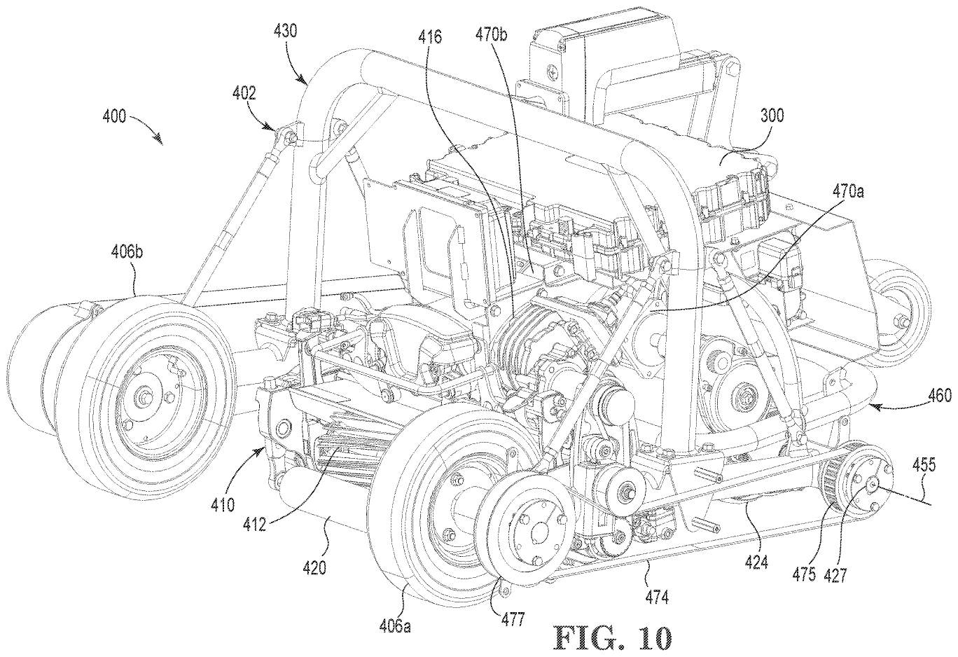

The vehicle may further include an implement subframe supporting a ground working implement. For example, when configured as a reel mower, the mower 400 may include a reel subframe 460 supporting a powered cutting reel assembly 410 as shown in FIG. 10 (various structure is removed in FIGS. 10 and 11 to illustrate features of the mower 400). As with the reel subframe 160, the reel subframe 460 includes a powered cutting reel 412 (powered by a reel motor 416 adapted to rotate the reel about a reel axis) and the drive drum 424 (section 424a, 424 b of FIG. 11). While described as a cutting reel assembly 410, the subframe 460 may support most any ground working implement without departing from the scope of this disclosure. As with the mower 100, the reel motor 416 (as well as the propulsion motors 470a, 470b described below) are electric motors that receive power from an onboard energy storage device such as a battery pack 300 as already described herein. However, such a configuration is exemplary only as other embodiments may utilize other motors (e.g., hydraulic motors) and other power sources (e.g., hydraulic pumps, internal combustion engines) without departing from the scope of this disclosure.

As shown in FIG. 11, the reel assembly 410 may further include front and rear rollers 420, 422 to support the cutting reel 412 relative to the ground surface 103 when in the operating configuration. To propel the mower 400 when in the operating configuration (e.g., during mowing), the drive drum 424 may be powered as further described below. An optional collection bin 426 (see FIG. 9) may also be provided to collect grass clippings produced by the cutting reel 412. While not shown, the mower 400 may also include a handle assembly (e.g., the handle assembly 200 as shown in FIGS. 1 and 2).

FIGS. 10-11 are partial perspective views of the mower 400 with various structure removed to better illustrate, among others, a propulsion system in accordance with embodiments of the present disclosure. The exemplary propulsion system may be configured to propel the mower when in both the operating (mowing) configuration and the transport (non-mowing) configuration.

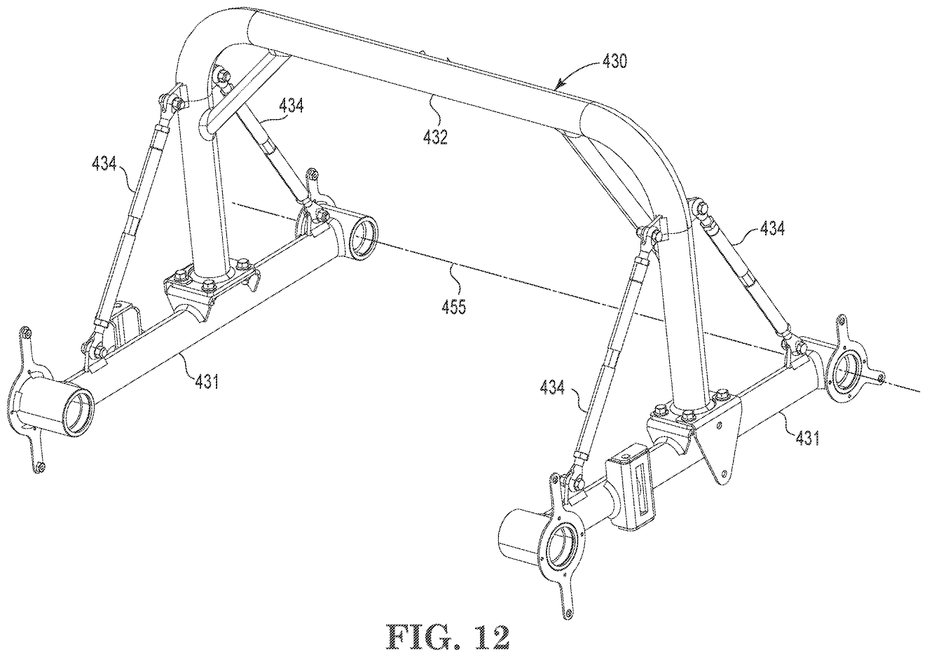

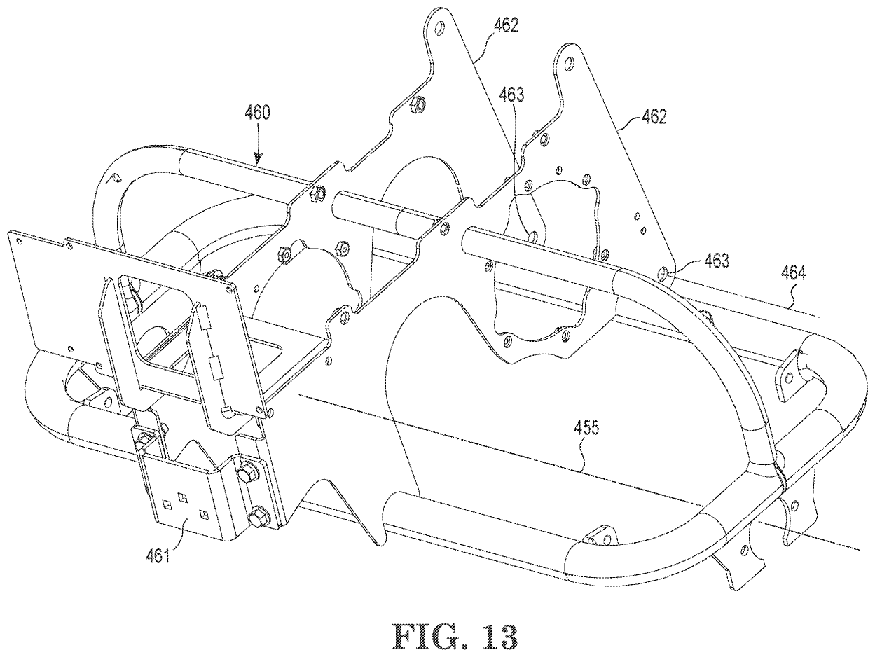

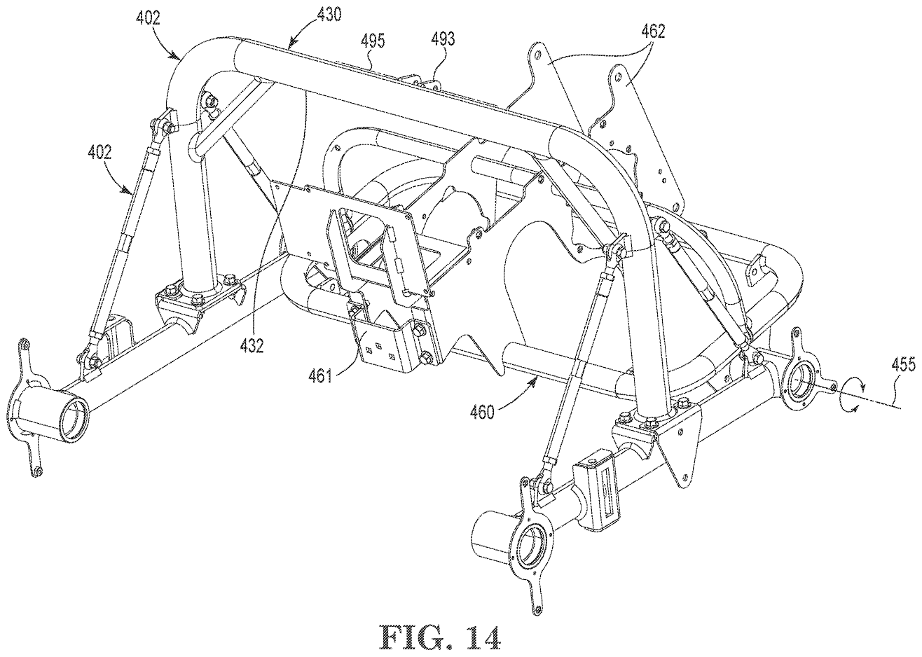

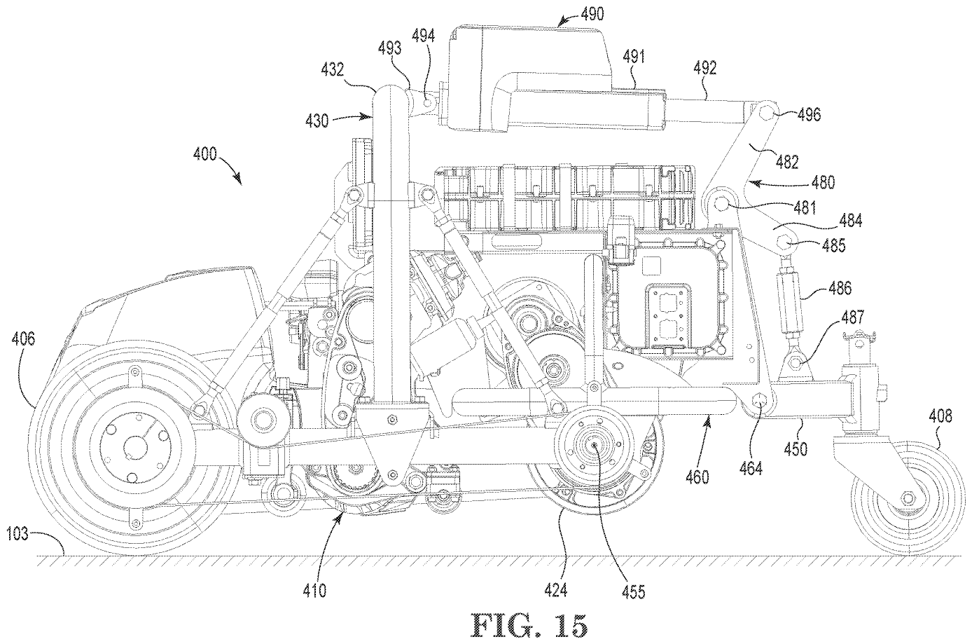

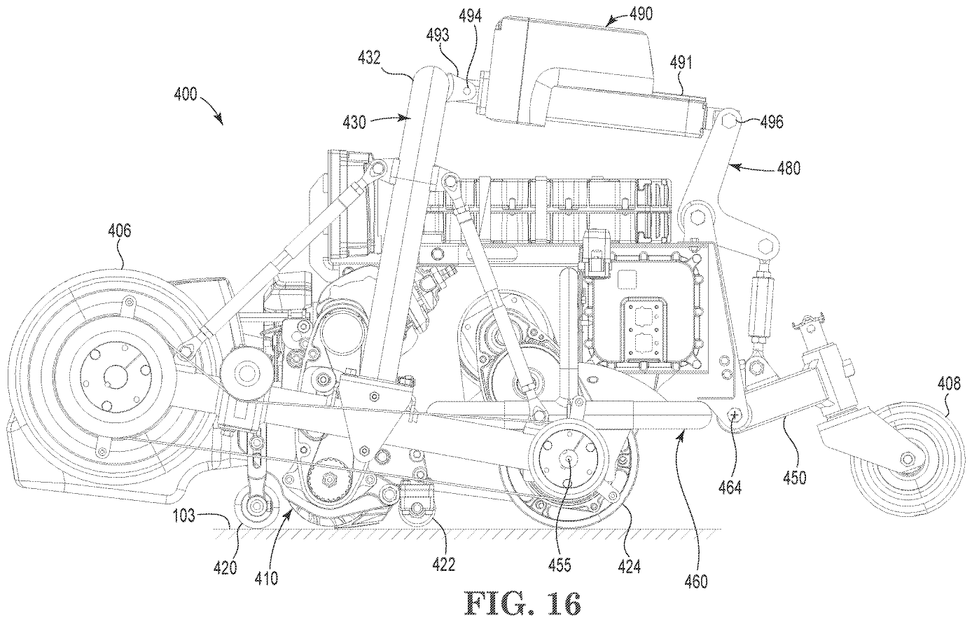

As indicated in these views, the frame assembly 402 may include a main frame 430 (see also FIGS. 12 and 14)—configured to support the drive drum 424 for rotation, relative to the main frame, about a transverse drive drum axis 455—and the reel subframe 460 supporting the cutting reel assembly 410 (see also FIGS. 13 and 14). The reel subframe 460 is pivotally connected to the main frame 430 about the transverse drum axis 455. The frame assembly may further include a trailing wheel subframe 450 (best shown in FIGS. 15 and 16) having the castering wheel 408. However, unlike the mower 100, the trailing wheel subframe 450 may be pivotally connected to the reel subframe 460 as further described below.

FIGS. 12, 13, and 14 illustrate, respectively, the exemplary main frame 430 in isolation, the reel subframe 460 in isolation, and the two components as assembled to form the frame assembly 402. As shown in these views, both the main frame 430 and the reel subframe 460 are formed by tubular weldments as opposed to the plate construction of the corresponding parts of the mower 100. The exemplary main frame 430 may include lateral first (left) and second (right) side tubes 431 that support journals for both the transport wheels 406 and the drive drum 424. Stated alternatively, the main frame 430 rotatably supports, and is pivotable relative to, the powered drive drum 424. The side tubes 431 are rigidly connected to one another by a transverse tube or crossbeam 432. In addition to rigid flanged (e.g., bolted) attachment of the crossbeam 432 to the side tubes 431, four tie rods 434 may also be included to provide additional rigidity of the main frame structure such that the tie rods 434, crossbeam 432, and side tubes 431 form a singular structure. As with the mower 100, the structure of the main frame 430 results in the transport wheels being effectively rotatably attached to the main frame at a location spaced-apart from the transverse drum axis 455.

As shown in FIG. 13, the reel subframe 460 includes structure to permit pivotal attachment to the main frame 430 such that the two components pivot relative to one another about the transverse drum axis 455. The reel subframe further includes features (e.g., mounting plate 461) configured to permit attachment of the cutting reel assembly thereto), and structure 462 defining apertures 463 configured to permit pivotal attachment of the trailing wheel subframe 450 (see FIG. 15) such that the trailing wheel subframe pivots, relative to the reel subframe, about a pivot axis 464. Accordingly, the reel subframe 460, and the attached trailing wheel subframe 450 may be pivotally coupled to the main frame 430 about the transverse drum axis 455 as shown in FIG. 14.

As with the drive drum 124 already described herein above, the drive drum 424 is configured to engage the ground surface and propel the reel mower (when in the operating configuration) by rotating about the drum axis 455. Accordingly, the drive drum may be split to provide independently rotatable, coaxial left drive drum portion or section 424a and right drive drum portion or section 424b (see FIG. 11). The first (left) and second (right) drive drum portions are powered by first (left) and second (right) propulsion motors 470a, 470b, respectively, as depicted in FIG. 11 (only left motor 470a shown in FIG. 11 but see FIG. 9). Thus the mower 400 may provide the same split drum advantages as those described above with reference to the mower 100. The motors 470 may each include a planetary gear box that, along with gears 471, 472, and 473 described below, may provide the desired drive ratio to the drive drum 424 without belts and pulleys.

With continued reference to FIG. 11, an exemplary propulsion system for use with the mower 400 may be powered by a power source, e.g., an energy storage device such as the battery pack 300, that, in some embodiments, is supported by the reel subframe 460, e.g., attached to structures 462 described above. Once again, the battery pack 300 may supply energy to at least: the electric reel motor 416 to provide power to the reel assembly 410; and left and right propulsion motors 470 secured to reel subframe 460.

Unlike the mower 100, the reel mower 400 may mount the reel motor 416 above the reel assembly 410 and provide driving power through a tensioned belt 417 entrained about an input sheave 419 connected to a driveshaft of the blades of the cutting reel 412. By positioning the reel motor 416 above the cutting reel as opposed as transversely thereto, the width of the mower may be reduced.

With continued reference to FIG. 11, each propulsion motor 470 may drive an output gear 471 adapted to mesh with an intermediate gear 472. The intermediate gear 472 may, in turn, mesh with an input gear 473 to which a drive shaft 427 of the respective drive drum section 424a, 424b of the drive drum is connected. As shown in FIG. 10, the drive shaft 427 may further protrude outwardly beyond the frame assembly 402 and have attached to an end thereof a drive sheave 475. A belt 474 may then be entrained about the drive sheave 475 and a wheel sheave 477 attached to a stub shaft connected to the associated transport wheel 406. As one can appreciate, relative movement of the main frame 430 relative to the reel subframe 460/trailing wheel subframe 450 (e.g., as the mower transitions between operating and transport configurations) has no impact on belt 474 tension and/or on the gears 471,472, and 473 as the respective (left and right-side) gears 471, 472, 473 and sheaves 475 and 477 move in fixed relation to the transverse drum axis 455.

Moreover, as with the mower 100, each propulsion motor 470 may drive both its respective wheel 406 and its respective drum section 424 at the same ground speed. As a result, the first and second drum sections are driven at a ground speed equivalent to the ground speed of the first transport wheel and the second transport wheel, respectively, during transition between the operating configuration and the transport configuration. Thus, transitioning between the operating configuration and the transport configuration may occur smoothly and without abrupt ground speed changes.

FIGS. 15 and 16 are partial side elevation views of the mower 400 (with various structure removed) in the transport and the operating configuration, respectively. Once again, in the transport configuration shown in FIG. 15, the implement/reel assembly 410 (including the drive drum 424) is elevated above the ground surface 103, while the transport wheels 406 and the trailing wheel 408 may engage or rest upon the ground surface 103 to support the mower 400 thereon. Powered, differential rotation of the transport wheels 406 may then propel and control speed and direction of the mower by rotating about the wheel axis (see wheel axis 107 in FIG. 3), the wheel axis being parallel to the drum axis.

Conversely, in the operating configuration shown in FIG. 16, the reel assembly 410 is lowered such that the implement (e.g., the front and rear rollers 420, 422) and the drive drum 424 engage or rest upon the ground surface 103, while the transport wheels 406 and the trailing wheel 408 are elevated or spaced-apart from the ground surface. Powered, differential rotation of the drive drum sections 424a, 424b (see FIG. 11) about the transverse drum axis 455 may propel the reel mower 400 when in the operating configuration (e.g., control both speed and direction of the mower).

To reconfigure the mower 400 between the transport configuration (FIG. 15) and the operating configuration (FIG. 16), the mower 400 may include an actuator, e.g., electric linear actuator 490 such as a ball screw operatively connected to the main frame and the trailing wheel subframe and adapted to pivot the main frame, relative to the reel subframe, about the transverse drum axis. The actuator may include a housing 491 and a rod 492 that may selectively extend and retract from the housing. The housing 491 may include a pivot 494 for pivotally attaching the actuator 490 to a bracket 493 fixed to the transverse crossbeam 432 (e.g., the actuator may connect to the main frame 430) such that the actuator may pivot about an actuator pivot axis 495 (see FIG. 14). The rod 492 also includes a pivot 496 configured to pivotally attach a distal end of the rod to a first arm 482 of a bellcrank 480 that is itself pivotally attached to the reel subframe via a pivot 481. A second arm 484 of the bellcrank 480 may pivotally attach to a first end of a tie rod 486 via a pivot 485. A second end of the tie rod 486 may connect to the trailing wheel subframe 450 at a pivot 487. As stated above, the trailing wheel subframe may be pivotally coupled to the reel subframe 460 via the apertures 463 such that it may pivot relative thereto about a pivot axis 464 (see FIG. 13). In some embodiments, an electronic controller 197 (see FIG. 5) may be provided and operatively connected to the actuator 490. The controller may be configured to transition the mower 400 between the operating and transport configurations automatically, e.g., by energizing the actuator.

Starting in the transport configuration (FIG. 15), the mower 400 may transition to the operating configuration (FIG. 16) by retracting the actuator 490 (e.g., retracting the rod 492 relative to (e.g., into) the housing 491). As the actuator 490 retracts, it causes the main frame 430 (due to connection at the bracket 493 on the crossbeam 432) to pivot clockwise about the transverse drum axis 455 relative to the reel subframe 460.

As this occurs, the trailing wheel subframe 450 will also pivot (counterclockwise in FIGS. 15 and 16) about the pivot axis 464. As this pivoting occurs, the reel subframe 460/reel assembly 410 will lower toward the ground surface 103 until the front and rear rollers 420, 422 and drive drum 424 rest thereon. During this transition, the trailing wheel subframe 450 will eventually lift the trailing wheel 408 away from the ground surface 103 as shown in FIG. 16. Moreover, the clockwise (in FIGS. 15 and 16) pivoting of the main frame 430 about the transverse drum axis 455 will also cause the transport wheels 406 to lift from the ground surface 103. Thus, as shown in FIG. 16, the reel assembly 410 (rollers, 420, 422) and drive drum 424 are in contact with the ground surface 103 when the mower is in the operating configuration. To transition back to the transport position, the actuator 490 may be extended, generally reversing the process described above.

The geometry of the frame assembly 402 (e.g., the main frame 430, the reel subframe 460, and the trailing wheel subframe 450) as well as the relative position of the motors 470 and battery pack 300 may result in the CG of the mower 400 remaining vertically above (located at a longitudinal position at) the drive drum 424 at least when in the operating configuration. This CG location may provide the mower 400 with improved balance and drive drum traction and steering control.

In some embodiments, the drive drum sections 424a, 424b (and 124a, 124b) may include a friction-enhancing surface. For example, the external cylindrical surface of the drive drum sections may have a rubber coating or sleeve that improves traction while minimizing turf damage. Other friction-enhancing surfaces may include: abrasive coatings; protrusions (studs); axial or helical grooves; and the like. Rubber or abrasive coatings on the drive drum may be preferred in some instances, to minimize visible marking the turf.

Aspects of the disclosure are provided in the claims. However, below is provided a non-exhaustive list of non-limiting examples. Any one or more of the features of these examples may be combined with any one or more features of another example, embodiment, or aspect described herein.

Example Ex1: A reel mower comprising: a main frame rotatably supporting, and pivotable relative to, a powered drive drum, the drive drum configured to engage a ground surface and propel the reel mower when the reel mower is in an operating configuration by rotating about a transverse drum axis; a reel subframe pivotally connected to the main frame about the transverse drum axis, the reel subframe supporting a powered cutting reel assembly; a trailing wheel subframe connected to the reel subframe; a powered transport wheel rotatably attached to the main frame at a location spaced-apart from the transverse drum axis, wherein the transport wheel is configured to engage the ground surface and propel the reel mower when the reel mower is in a transport configuration by rotating about a wheel axis parallel to the transverse drum axis; and an actuator operatively connected to the main frame and to the trailing wheel subframe, wherein the actuator is adapted to pivot the main frame, relative to the reel subframe, about the transverse drum axis between: the operating configuration, wherein the drive drum is engaged with the ground surface and the transport wheel is elevated above the ground surface; and the transport configuration, wherein the drive drum is elevated above the ground surface and the transport wheel is engaged with the ground surface.

Example Ex2: The reel mower of Example Ex1, wherein the powered transport wheel comprises a first transport wheel located at a first lateral side of the main frame and a second transport wheel located at a second lateral side of the main frame opposite the first lateral side.

Example Ex3: The reel mower of Example Ex2, wherein the first and second transport wheels are powered by first and second propulsion motors, respectively.

Example Ex4: The reel mower of any one of Examples Ex1-Ex3, wherein the powered cutting reel assembly is powered by a reel motor.

Example Ex5: The reel mower of any one of Examples Ex1-Ex4, further comprising an energy storage device supported by the trailing wheel subframe.

Example Ex6: The reel mower of any one of Examples Ex1-Ex4, further comprising an energy storage device supported by the reel subframe.

Example Ex7: The reel mower of any one of Examples Ex1-Ex6, further comprising a front end, a rear end, and a longitudinal axis extending between the front and rear ends, wherein a center of gravity of the reel mower is located at a longitudinal position at or forward of the transverse drum axis when the reel mower is in both the operating configuration and the transport configuration.

Example Ex8: The reel mower of any one of Examples Ex1-Ex7, further comprising an electronic controller configured to transition the mower between the operating and transport configurations automatically.

Example Ex9: The reel mower of any one of Examples Ex1-Ex8, wherein the trailing wheel subframe is pivotally connected to the reel subframe.

Example Ex10: The reel mower of any one of examples Ex1-Ex9, wherein the drive drum comprises independently rotatable, coaxial first and second drum sections, wherein the first drum section is powered by a first propulsion motor and the second drum section is powered by a second propulsion motor.

Example Ex11: The reel mower of Example Ex10, wherein the first drum section and the second drum section are driven at a ground speed equivalent to the ground speed of the first transport wheel and the second transport wheel, respectively, during transition between the operating configuration and the transport configuration.

Example Ex12: The reel mower of any one of Examples Ex1-Ex11, wherein the main frame further comprises a transverse crossbeam, and wherein the actuator is operatively connected to the transverse crossbeam and to the trailing wheel subframe.

Example Ex13: The reel mower of any one of Examples Ex1-Ex12, wherein the actuator comprises a linear actuator.

Example Ex 14: The reel mower of any one of Examples Ex1-Ex-13, further comprising an operator handle assembly extending from the main frame.

Example Ex15: A ground working vehicle comprising: a main frame configured to support a powered drive drum for rotation, relative to the main frame, about a transverse drum axis; an implement subframe pivotally connected to the main frame about the transverse drum axis, the implement subframe supporting a ground working implement; a trailing wheel subframe pivotally connected to the implement subframe, the trailing wheel subframe comprising a castering wheel; a powered transport wheel rotatably attached to the main frame at a location spaced-apart from the transverse drum axis; and an actuator operatively connected to the main frame and to the trailing wheel subframe, wherein the actuator is adapted to pivot the main frame relative to the implement subframe about the transverse drum axis between: an operating configuration, wherein the drive drum and the implement are engaged with a ground surface and both the transport wheel and the castering wheel are elevated above the ground surface; and a transport configuration, wherein the drive drum and implement are elevated above the ground surface and both the transport wheel and castering wheel are engaged with the ground surface.

The complete disclosure of the patents, patent documents, and publications cited herein are incorporated by reference in their entirety as if each were individually incorporated. In the event that any inconsistency exists between the disclosure of the present application and the disclosure(s) of any document incorporated herein by reference, the disclosure of the present application shall govern.

Illustrative embodiments are described and reference has been made to possible variations of the same. These and other variations, combinations, and modifications will be apparent to those skilled in the art, and it should be understood that the claims are not limited to the illustrative embodiments set forth herein.

1. A reel mower comprising:
a main frame rotatably supporting, and pivotable relative to, a powered drive drum, the drive drum configured to engage a ground surface and propel the reel mower when the reel mower is in an operating configuration by rotating about a transverse drum axis;
a reel subframe pivotally connected to the main frame about the transverse drum axis, the reel subframe supporting a powered cutting reel assembly;
a trailing wheel subframe connected to the reel subframe;
a powered transport wheel rotatably attached to the main frame at a location spaced-apart from the transverse drum axis, wherein the transport wheel is configured to engage the ground surface and propel the reel mower when the reel mower is in a transport configuration by rotating about a wheel axis parallel to the transverse drum axis; and
an actuator operatively connected to the main frame and to the trailing wheel subframe, wherein the actuator is adapted to pivot the main frame, relative to the reel subframe, about the transverse drum axis between:
the operating configuration, wherein the drive drum is engaged with the ground surface and the transport wheel is elevated above the ground surface; and
the transport configuration, wherein the drive drum is elevated above the ground surface and the transport wheel is engaged with the ground surface.

2. The reel mower of claim 1, wherein the powered transport wheel comprises a first transport wheel located at a first lateral side of the main frame and a second transport wheel located at a second lateral side of the main frame opposite the first lateral side.

3. The reel mower of claim 2, wherein the first and second transport wheels are powered by first and second propulsion motors, respectively.

4. The reel mower of claim 1, wherein the powered cutting reel assembly is powered by a reel motor.

5. The reel mower of claim 1, further comprising an energy storage device supported by the trailing wheel subframe.

6. The reel mower of claim 1, further comprising an energy storage device supported by the reel subframe.

7. The reel mower of claim 1, further comprising a front end, a rear end, and a longitudinal axis extending between the front and rear ends, wherein a center of gravity of the reel mower is located at a longitudinal position at or forward of the transverse drum axis when the reel mower is in both the operating configuration and the transport configuration.

8. The reel mower of claim 1, further comprising an electronic controller configured to transition the mower between the operating and transport configurations automatically.

9. The reel mower of claim 1, wherein the trailing wheel subframe is pivotally connected to the reel subframe.

10. The reel mower of claim 2, wherein the drive drum comprises independently rotatable, coaxial first and second drum sections, wherein the first drum section is powered by a first propulsion motor and the second drum section is powered by a second propulsion motor.

11. The reel mower of claim 10, wherein the first drum section and the second drum section are driven at a ground speed equivalent to the ground speed of the first transport wheel and the second transport wheel, respectively, during transition between the operating configuration and the transport configuration.

12. The reel mower of claim 1, wherein the main frame further comprises a transverse crossbeam, and wherein the actuator is operatively connected to the transverse crossbeam and to the trailing wheel subframe.

13. The reel mower of claim 1, wherein the actuator comprises a linear actuator.

14. The reel mower of claim 1, further comprising an operator handle assembly extending from the main frame.

15. A ground working vehicle comprising:
a main frame configured to support a powered drive drum for rotation, relative to the main frame, about a transverse drum axis;
an implement subframe pivotally connected to the main frame about the transverse drum axis, the implement subframe supporting a ground working implement;
a trailing wheel subframe pivotally connected to the implement subframe, the trailing wheel subframe comprising a castering wheel;
a powered transport wheel rotatably attached to the main frame at a location spaced-apart from the transverse drum axis; and
an actuator operatively connected to the main frame and to the trailing wheel subframe, wherein the actuator is adapted to pivot the main frame relative to the implement subframe about the transverse drum axis between:
an operating configuration, wherein the drive drum and the implement are engaged with a ground surface and both the transport wheel and the castering wheel are elevated above the ground surface; and
a transport configuration, wherein the drive drum and implement are elevated above the ground surface and both the transport wheel and castering wheel are engaged with the ground surface.
